(19) United States
(12) Patent Application Publication
(10) Pub. No.: US 2019/0389011 A1
(43) Pub. Date: Dec. 26, 2019

(54) METHOD AND ARRANGEMENT FOR LASER-BASED PROCESSING

(71) Applicant: Stora Enso OYJ, Helsinki (FI)

(72) Inventor: Nina Miikki, Imatra (FI)

(21) Appl. No.: 16/465,291

(22) PCT Filed: Nov. 30, 2017
(86) PCT No.: PCT/IB2017/057527

§ 371 Date: May 30, 2019

(30) Foreign Application Priority Data
Dec. 1, 2016 (SE) 1651584-3

(51) Int. Cl. B23K 26/402; B23K 26/082; B23K 26/142; B23K 26/38

(52) U.S. Cl. CPC B23K 26/402; B23K 26/082; B23K 2103/40; B23K 26/38; B23K 26/142

(57) ABSTRACT

Method (200) for non-contact processing of fibrous material comprising providing (206) a blank of fibrous material, providing (204) a laser processing equipment, said equipment being configured to exhibit a laser emission substantially at a wavelength falling within a range from 120 about 2 to about 10.4 10.3 microns, and subjecting (210, 210A, 210B) the blank to a laser beam of the laser processing equipment to produce a target design therefrom, incorporating directing the beam to the blank following a selected pattern in accordance with the target design. Arrangement (100) for implementing the method is presented.

### FIELD OF THE INVENTION

Generally the present invention relates to industrial processing of materials. In particular, however not exclusively, the present invention concerns laser cutting of especially fibrous products such as cardboard.

### BACKGROUND

Laser-based processing, such as cutting, engraving, perforating and carving, for example, of target elements has turned out in many ways a superior solution relative to a number of more traditional mechanical alternatives involving turning, milling, and drilling e.g. by a lathe, milling machine, or a drill press, respectively.

Laser can be utilized in processing metals, ceramics, plastics, textile, leather, paper, cardboard, wood, and even glass. Depending on the used laser and target material, the laser may be configured to burn, melt or vaporize the target. Assist gas may be exploited in evacuating the molten kerf material and/or improving the cutting effect in terms of elevated cutting energy (heat).

Having regard to the end applications the laser cutters or engravers may have, packaging and generally prototype construction are both feasible examples of the same. With laser processing such as cutting, the often critical duration between designing a concept and completing a first prototype or a production item can be reduced considerably in contrast to many classical mechanical processing options.

A modern laser cutter is capable of providing relatively clean cut edges, versatile cut shapes and flexible end design, excellent cutting accuracy, narrow kerf, and relatively high process speed/throughput, while it only suffers, as a non-contact tool, from minimal wear (virtually no wear), induces typically rather tolerable operation costs, and omits various contamination problems of the tool itself and also of the target material, which are more common problems with contact-based mechanical cutting solutions that are negatively affected by dust that has come off from the processed material, for example. Dust is also a concern with traditional blade or generally mechanical type cutting methods.

Notwithstanding the recent advantages in the realm of laser processing and especially cutting, there still are few issues that would benefit from further innovative development of the laser cutting equipment and related features.

Particularly in connection with fibrous products such as the aforementioned paper, wood and cardboard, it has been noticed that the cut edges of the processed material usually exhibit black, brown or brownish color, i.e. burn/heat marks, caused by the laser due to e.g. combusted air or nitrogen adjacent the surface of the material. Also hot debris causes such marks in addition to fumes. The marks are visually easily perceivable from the remaining material. Depending on the applied visual quality criterion, such marks may even be considered substantial artifacts that basically mar the product.

To avoid the aforesaid artifacts especially in connection with laser cutting that is more energy intensive and therefore susceptible to cause more severe burn marks in contrast to e.g. lower energy requiring engraving activities, the target material may be in some cases pre-treated or ‘pre-protected’ either chemically or mechanically/physically. For instance, a workpiece may be provided with a protective backing or a masking tape to reduce heat stress introducing reflections from the underlying support structure or cutting bed to the reverse of the material. However, the related installation and removal of additional layers or elements is tedious and requires additional processing stages. Besides, depending on e.g. the moisture content of the target material, removal of the protective elements may cause additional damage of its own such as ripping of the material. Even the burn marks may ultimately turn out more annoying than without protective features.

Further, in addition to mere visual artifacts caused by laser cutting and related edge burning, the target material may catch additional odors, which may be particularly problematic in the context of e.g. foodstuff and related packaging. The packed groceries may adopt the odor from the laser-cut packaging, for instance. Even taste flaws such as strange flavors are possible.

### SUMMARY

The objective of the present invention is to at least alleviate one or more of the above drawbacks associated with the existing solutions in the context of laser cutting, having regard to especially fibrous and typically also organic materials.

The objective is achieved with the embodiments of a method and related processing arrangement in accordance with the present invention.

According to one embodiment of the present invention, a method for non-contact processing, preferably cutting, of fibrous material comprises

providing a blank of fibrous material,
providing a laser processing equipment, said equipment being configured to exhibit a laser emission substantially at a wavelength falling within a range from about 2 to about 10.3 or 10.4 microns, optionally at about 9.3 microns or 10.3 microns, and
subjecting the blank to a laser beam of the laser processing equipment to produce a target design therefrom, incorporating directing the beam to the blank following a selected pattern in accordance with the target design.

According to one other embodiment, an arrangement for non-contact processing, preferably cutting, of a fibrous blank, comprises

a laser module containing a laser source configured to exhibit a laser emission substantially at a wavelength falling within a range from about 2 to about 10.4 microns, and
a motion control system configured to direct a laser beam emitted by the laser module to the blank following a selected pattern so as to produce a target design therefrom.

Different considerations presented herein concerning the embodiments of the method may be flexibly applied to the embodiments of the arrangement mutatis mutandis, and vice versa, as being appreciated by a skilled person. The arrangement may itself comprise one or more at least functionally connected apparatuses depending on the embodiment.

The utility of the present invention arises from a plurality of issues depending on the particular embodiment in question. First of all, the suggested wavelength has been surprisingly found particularly suitable for highly accurate, industrial scale processing, such as cutting, drilling/perforating, creasing and engraving, of many fibrous and optionally organic materials, including paper or paperboard. The absorption of laser radiation at that wavelength has been turned out particularly effective in terms of e.g. material cutting or generally ablation, involving removal of the target material to at least some extent.

Accordingly, visual defects such as discoloration, e.g. tan, of the cut edges may be reduced together with the needed laser intensity and power, while the processing speed such as cutting, drilling or engraving speed may remain intact or be even increased. The provided kerfs may be narrow and exhibit good visual quality (smoothness, color, etc.).

The risk of catching strange flavors or odors by sensitive products such as foodstuff positioned within or adjacent a piece of laser-processed material may be reduced as well.

Still, the formation of sticky, hard-to-remove dust, which is a common but undesired by-product of mechanical processing of fibrous material, is reduced due to the suggested wavelength and power adaptation. With many mechanical cutting, drilling or engraving solutions, hot dust arising from e.g. various minerals of the fibrous target material is easily stuck to the areas close to the cut region, whereupon removal thereof requires additional process phases and prove surprisingly difficult.

The overall duration from a design plan to a ready formed prototype or final product, e.g. a package of a consumer or other type of a item to be at least partially enclosed within the package, can be shortened.

Technically, the set forth wavelength and related potential further optimization (power, control speed, etc.) of laser-based processing of fibrous materials can be attained through the utilization of fixed or tunable wavelength lasers operable at the suggested wavelength. E.g. gas lasers, particularly CO₂ lasers, capable of emitting that wavelength with good efficiency are sufficient output power are generally applicable but also other laser technologies may be harnessed for the purpose.

Different embodiments of the present invention are described in the detailed description and disclosed in the attached dependent claims.

Also various further benefits of different embodiments of the present invention are disclosed in the detailed description hereinafter.

The expression “a number of” may herein refer to any positive integer starting from one (1).

The expression “a plurality of” may refer to any positive integer starting from two (2), respectively.

The ordinal numbers such as “first” and “second” are herein used to distinguish one element from other element, and not to specially prioritize or order them, if not otherwise explicitly stated.

### BRIEF DESCRIPTION OF THE DRAWINGS

Next the present invention will be described in greater detail with reference to the accompanying drawings, in which:

FIG. 1 illustrates one embodiment of an arrangement in accordance with the present invention.

FIG. 2 is a flow diagram disclosing an embodiment of a method in accordance with the present invention.

FIG. 3 is a sketch of a use scenario involving an embodiment of a method and arrangement in accordance with the present invention.

### DETAILED DESCRIPTION

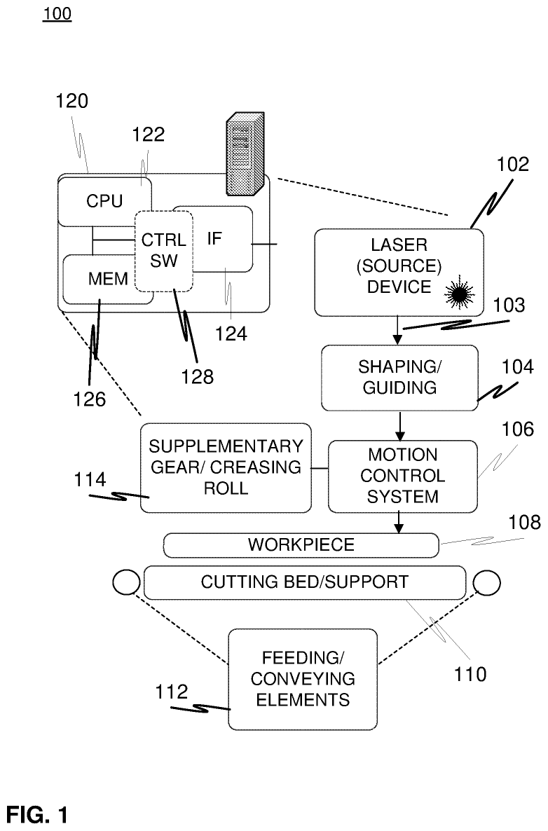

FIG. 1 illustrates, at 100, an embodiment of the arrangement suggested herein.

A laser processing equipment 102, which may be embodied as one or more at least functionally, such as electrically and/or optically, connected components or devices, comprises a laser source such as CO₂ or other suitable laser of gas, fiber, solid-state, chemical, etc. type. A person skilled in the art may select an applicable laser based on e.g. emission wavelength, power consumption, output power, dimensions, price, availability or other features embodiment-specifically.

It may be still mentioned that at the time of writing in many embodiments CO₂ type gas lasers will provide good if not best solution having regard to the power, overall performance such as controllability and cut quality, and e.g. compact size. The laser may be of continuous wave or pulsed type. The laser may be of sealed type, for instance. The laser may be cooled using e.g. air or liquid (e.g. water).

The output power of the selected laser is preferably at least about 100 Watts. It may be several Kilowatts or even more depending on the embodiment. Where process speed is not an issue and the material to be processed is trouble-free to process (e.g. thin and absorbs the emitted wavelength effectively), also less powerful laser may be considered. The speed of the laser processing such as cutting or engraving may vary depending on the target material, its dimensions and other parameters such as quality objectives of each embodiment. It may thus be only a few centimetres per minute or even several meters per minute, for instance.

The intensity (optical power per unit area) or related beam width may vary depending on the embodiment. The beam diameter at the focus spot may be about one or few hundred microns, or more.

Preferably, the emitted wavelength falls within range between one or few microns and about 10.4 microns, preferably between about two microns and about 10.3 microns, more preferably between about 9 and about 10.3 microns, and most preferably between about 9.2 and 9.6 microns, i.e. being e.g. about 9.3 microns. In some applications about 10.3 micron wavelength (e.g. 10.25 microns) has been found particularly advantageous.

Such wavelengths have turned out surprisingly promising in view of the efficiency of executed laser processing such as cutting, naturally depending on the utilized fibrous target material. The wavelength of the laser may be fixed or in some optional alternative embodiments, (re-)tunable, optionally by the operator thereof via an applicable UI (user interface).

Preferably, the wavelength is selected having regard to the absorption characteristics and chemical composition of the target material so that the processing efficiency is optimized in terms of associated (minimized) energy consumption, process speed (sufficient or maximized) and quality (e.g. approvable cut edge appearance and e.g. smoothness).

A number of elements such as a beam expander to adjust beam diameter, a directing mirror, and/or lenses 104, such as collimation/focusing lenses, may be optionally provided on the optical path of the laser 102 to process or direct the beam 103 emitted by the laser 102 towards a blank, i.e. a (work)piece of target material 108 to be processed, optionally cut or e.g. engraved by the laser. Generally item 104 thus encompasses e.g. beam shaping and/or guiding.

With cutting it is typically referred herein to completed removal and separation of material from the top surface to the bottom surface thereof along a selected path. The path may be a straight cut or shortest path cut through the material or e.g. a slanting cut.

For example, a selected target angle of incidence at the material 108 surface may be obtained for the beam through the configuration of elements 104 when necessary. In some embodiments, right angle may be desired to obtain e.g. straight, shortest path cut through the material. At least part of the elements 104 could be optionally located in some embodiments within the laser equipment 102, e.g. within a common housing.

The (work) piece 108 may refer to a film, sheet, plate, multilayer element, etc. It may be substantially planar or exhibit a clear 3d-shape (e.g. with varying thickness or height, i.e. ‘Z’ component). The piece 108 may define a number of curved, angular, or honeycombed shapes, for instance.

In some embodiments, the piece 108 may refer to a roll or e.g. elongated larger piece that is laser processed step by step or in one go. For example, it may be cut into smaller pieces prior to, during or after laser processing.

The piece 108 may include e.g. paper or cardboard. The thickness of the material may vary between the embodiments. For instance, typical paper thickness may be about few tens of micrometres or more, e.g. about 0.1 millimetres, whereas cardboard, such as corrugated cardboard, may easily be at least several millimetres or even few tens of millimetres thick.

The processed piece 108 may be cultivated into a final target design, such as a product package, container, an information card (e.g. ID card or business card, or even a postcard), a label, a poster, etc.

In some embodiments, the laser processed piece 108 may be utilized for establishing a target design through 3D printing. For example, a plurality of laser-cut pieces 108 may be stacked together to establish a three-dimensional target object. Optionally, the arrangement 100 incorporates 3D printing equipment.

In some embodiments, the laser processed piece 108 may host electronics such as electronic traces and/or components, which may be printed using additive printing technologies such as screen printing or ink jetting, and/or mounted using e.g. solder and/or conductive adhesive. The related elements may be provided prior to, upon or after laser processing.

Item 106 refers to a motion control system that may include a number of components and/or devices. With the help of the motion control system 106, the laser beam 103 may be directed to desired locations of the piece 108 and/or along a desired, typically pre-programmed, route on the target material of the target piece 108. This involves relative movement of the laser beam 103 and the piece 108. Accordingly, a desired processing pattern such as drill and/or cut pattern is established and target design set for the processed piece finally obtained after laser and optional further processing. The motion control system 106 is optically and/or mechanically connected to the laser 102/laser beam 103 and/or to elements 104 depending on the embodiment as being clear to a skilled person based on the more detailed explanation of potential embodiments below.

In some embodiments, a scanning solution or a ‘scanner’, such as a galvo (galvanometric) scanner, may be included to dynamically direct the laser beam 103 over static workpiece 108.

For steering the beam 103, the scanner may therefore incorporate a number of, typically a plurality of, rotatable, motor-driven mirrors. Such solution offers fast process speed but the working area may be smaller than in some competing solutions. Also basic requirements for the beam quality (focus and collimation/diameter) may be higher. In the context of cutting, this scanner-type motion control may be referred to as ‘remote cutting’.

In connection with item 106 or 104 (the latter option being particularly applicable when 106 does not contain additional elements on the optical path such as scanning mirrors), a number of further optical element(s) such as a focusing or scan lens possibly including e.g. a telecentric such as a so-called F-Theta lens, may be included to provide e.g. a focused beam from item 106 that is substantially perpendicular to the target surface. The aim is to provide flat field on the image plane over the scan field.

In some embodiments, e.g. a gantry type flatbed solution may be utilized and implemented by the motion control system 106. It is generally a question of so-called flying optics type solution, where the workpiece 108 may remain static while a cutting/processing head wherefrom the laser beam 103 ultimately exits towards the workpiece 108 moves thereon in horizontal dimensions, when in use, typically as assisted by a plurality of (servo) motors.

In some embodiments, a hybrid solution is selected, where both the workpiece 108/support 110 and the cutting/processing head, and thus the emitted laser beam, are configured to move, one along a certain axis (X) and the other along a perpendicular axis (Y), which axes are both preferably substantially parallel to the material surface or underlying support 110.

In some embodiments, a moving (X-Y) table, or fixed optic, type solution may be adopted where only the material 108/support 110 is moved while the laser beam 103 remains static. The support 110 may be motorized, for instance.

In some embodiments, the support 110 may include metal such as aluminium or steel. It may define a substantially continuous, flat contact area for the workpiece 108. However, it may also define e.g. a more or less dense honeycomb or lamella (e.g. slat) structure with recesses and/or through-holes to implement a more versatile laser/cutting bed.

Preferably the material and overall configuration (e.g. geometry and structure, including recesses) of the support 110 are indeed selected so as to enhance energy absorption and/or diffusion of the incident laser energy. This is to reduce burn marks especially on the reverse side of the workpiece 108 contacting the support 110 as lesser amount of energy is thus back-scattered potentially also with a wider spatial distribution to the piece 108 to avoid local damages thereat. However, with flexible materials such as paper the support 110 shall contain enough support or contact surface to keep the material substantially flat during laser processing in favour of processing accuracy. Therefore, the applied honeycomb, lamella or similar structure shall not be excessively sparse.

Yet, the arrangement may include various other elements such as pre-treatment, post-treatment, finishing, feeding, support, protecting, inspection (e.g. camera or machine vision system, or other sensing equipment) and/or conveying gear 112 including e.g. motorized rolls or rollers, conveyor belt, robotic arms/robots, levels, ramps, etc. In some embodiments, roll-to-roll type processing model may be implemented whereas in some other embodiments, the material supply may be roll-based but the roll is cut in separate product pieces during processing, optionally by laser.

In some embodiments, laser processing may separate a number of smaller pieces from the original workpiece through cutting. Such cut-away portions of the main material/main piece may be leftovers, while the remaining main piece establishes the selected target design. Alternatively, the smaller piece(s) may solely or additionally establish target design(s) for further exploitation such as folding a product package therefrom, depending on the embodiment.

In connection with laser 102, shaping/guiding 104 and/or motion control system 106, or more remotely, further equipment 114 such as assist gas provision sub-system with necessary tanks, compressors and/or nozzles may be provided. The gas may incorporate evacuation gas to remove debris and/or reactive gas to improve the cutting characteristics or the quality of the cut, e.g. reduced burn marks and kerf width. Both gases and related functions may involve utilization of e.g. compressed air or nitrogen.

Alternatively or additionally, creasing equipment may be configured, including e.g. a roll, and optionally provided in connection with the cutting/processing head of the laser.

In some embodiments, the laser 102 or a second laser, may be applied to establish the desired creases or a crease pattern on the piece 108. The pattern may generally follow e.g. the intended edges of the package or other structure to be folded from the laser-processed piece 108 thus acting as a preform for such procedure.

Yet in some embodiments, lamination (heat, pressure), molding, printing or mounting equipment is provided. For example, the workpiece 108 may be provided with additional functional and/or aesthetic (e.g. graphical, colored, etc.) layers. As alluded to previously, electronics may be provided to establish a smart device such as a sensor, a communication or indication device, a memory device, a processing device, or a desired combination of such.

Item 120 refers to a control system at least functionally, such as electrically, coupled to one or more of the remaining entities such as the laser 102, shaping/guiding items 104, motion controller 106, supplementary equipment 114, and/or elements 112. Preferably at least the motion control system 106 and/or the laser itself 102 are automatically controlled by the system 120 in accordance with an operator/user-configured program.

The system 120 may include at least one processing unit 122 such as a microprocessor, microcontroller, digital signal processor (DSP), etc. for executing instructions in the form of e.g. (C)NC code such as G-code or other numerical control code, or generally a computer program 128 stored in memory 126, which may refer to one or more memory chips optionally integral with the processing unit 122. A data interface such as a serial or parallel interface 124 may be provided for communication with other elements of the arrangement 100, which shall naturally contain compatible data interfaces, and optionally external control or monitoring systems. The interface 124 may be a wired or wireless one and follow e.g. selected LAN (local area network) or cellular standard.

Yet, the interface 124 or generally device 120 may implement a user interface for obtaining user input and providing user output. A touch screen, a touch pad, a keypad, a keyboard, a mouse, a display, a loudspeaker or buzzer, a tactile feedback device such as a vibration motor, a number of indicator lights, buttons, switches, speech input interface, etc. may be arranged.

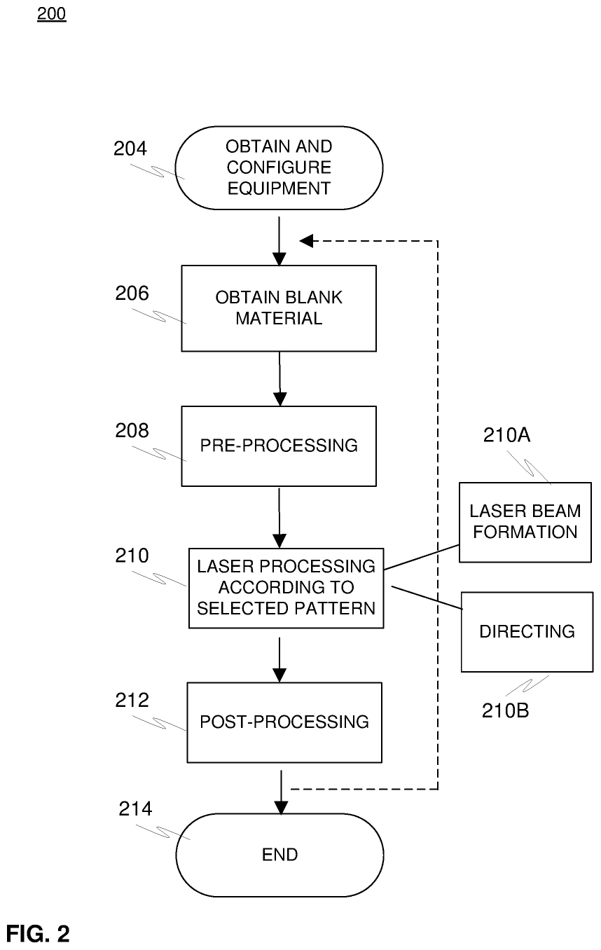

FIG. 2 includes a flow diagram 200 disclosing an embodiment of a method in accordance with the present invention.

At the beginning of the method for processing a piece, or blank, of fibrous material with a laser, a start-up phase 204 may be executed. During the start-up 204, various preparative tasks such as material, component and equipment selection, acquisition, calibration and configuration may take place. Specific care must be taken that the individual devices, systems and material selections ultimately work together, which is naturally preferably checked up-front on the basis of the manufacturing process specifications and component data sheets, or by investigating and testing the produced prototypes, for example. The used equipment such as laser equipment, among others, may be thus ramped up to operational status at this stage.

At 206, a piece, or blank, of target material(s) is obtained. A ready-made element of preferably fibrous material, e.g. a roll or sheet, may be acquired, for example. In some embodiments the workpiece to be laser processed may be first produced in-house by suitable method(s) that may involve milling, molding, extrusion and/or other methods. In some embodiments, 3D printing could be harnessed into producing at least portion of the blank.

Optionally, at 208, the material(s) are (pre-)processed, which may include, for example, creasing, coating, coloring, and/or lamination. A multilayer structure of mutually similar or different stacked layers in terms of materials and/or configuration (e.g. corrugated cardboard) may be established for laser processing.

At 210, laser processing takes place, which may refer to cutting, perforating and/or engraving, for instance. The processing may involve several activities such as actually lasering 210A the surface of the workpiece (i.e. providing the laser beam towards the surface so that the desired laser-based interaction therewith such as burning, melting or vaporization takes place) and moving the workpiece relative to the laser beam 210B, which may in practice comprise moving the beam, workpiece/support or both in order to establish the desired target design. The activities may be executed sequentially or simultaneously.

At 212, the processed workpiece may be post-processed. Potential post-processing tasks include lamination, coating, creasing, coloring, packing, protecting, marking, decorating (e.g. printed or laminated graphics), molding, provision of additional elements such as electronics, etc. At least some of the tasks may be alternatively or additionally executed during or between laser processing activities 210. For example, creasing could take place in connection with laser processing notwithstanding the fact whether it is accomplished by the same or additional laser or via completely other type of an element such as a roll.

Yet at 212, the workpiece could be also shaped to establish a desired structure, i.e. target design. In the case of a packaging box blank for a target item, for instance, the box could be formed from the laser processed blank through folding it into use-position. The item could be then inserted in the box. Instead of a box, the processed blank could be configured to establish e.g. a pallet, mug, other type of a container, label, sign, flyer, identification or generally information card, access card, etc.

As mentioned hereinbefore, the processed workpiece may be utilized in 3D printing (additive manufacturing) to establish a part, such as a layer, of a larger three-dimensional target object. Basically multiple laser processed (cut, for example) workpieces may be stacked together to construct the object.

At 214, the method execution is ended. The dotted loop-back arrow indicates the potentially repetitive nature of various method items as being easily understood by a person skilled in the art.

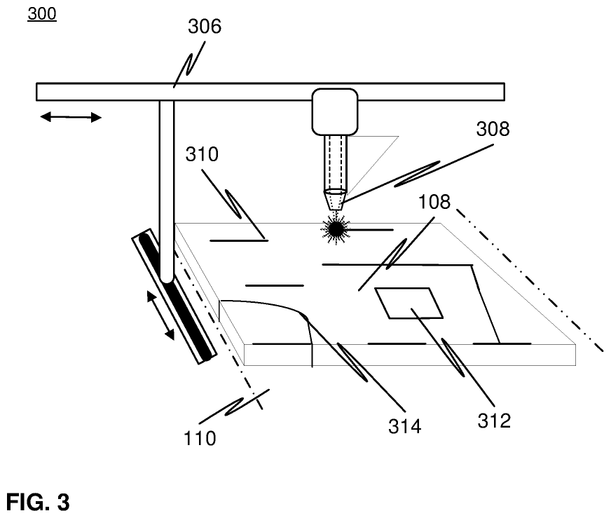

FIG. 3 illustrates, at 300, an axonometric sketch of one possible use scenario of the present invention comprising an embodiment of a gantry type flatbed laser equipment 306 for laser processing such as cutting, perforating, creasing and/or engraving. A piece of target material 108 to be processed has been positioned on a support 110, which may include e.g. absorptive and/or diffusive bed. The equipment 306 contains a laser head portion 308 wherefrom the laser beam exists directly towards the workpiece 108. The laser output may establish on the workpiece different rounded 314, angular 312 or linear 310 shapes and patterns e.g. in the form of integral engravings, such as grooves, or cut-away portions.

The scope of the present invention is determined by the attached claims together with the equivalents thereof. A person skilled in the art will appreciate the fact that the disclosed embodiments were constructed for illustrative purposes only, and other arrangements applying many of the above principles could be readily prepared to best suit each potential use scenario.

1. A method for non-contact processing of fibrous material comprising:
providing a blank of fibrous material,
providing a laser processing equipment, said equipment being configured to exhibit a laser emission substantially at a wavelength falling within a range from about 2 to about 10.4 microns, and
subjecting the blank of fibrous material to a laser beam of the laser processing equipment to produce a target design therefrom, incorporating directing the laser beam to the blank of fibrous material following a selected pattern in accordance with the target design.

2. The method of claim 1, wherein the fibrous material is or includes paper or cardboard.

3. The method of claim 1, wherein the blank of fibrous material is a substantially planar sheet of said fibrous material.

4. The method of claim 1, wherein the blank of fibrous material exhibits a substantially non-planar, three-dimensional shape, optionally curved, angular or honeycombed shape.

5. The method of claim 1, wherein said non-contact processing includes cutting, perforating, engraving, creasing, or a combination thereof.

6. The method of claim 1, wherein the laser processing equipment comprises a gas laser.

7. The method of claim 1, wherein the wavelength falls within a range from about 9.3 to 9.6 microns.

8. The method of claim 1, wherein the wavelength is about 10.3 microns.

9. The method of claim 1, wherein an output power of the laser processing equipment is about 100 Watts or more.

10. The method of claim 1, wherein the laser beam is shaped on an optical path from a laser source to the blank of fibrous material.

11. The method of claim 1, wherein the laser beam, the blank of fibrous material, or both are moved in relation to each other by a motion control system so that the selected pattern is followed by the laser beam.

12. The method of claim 11, wherein the motion control system includes a scanner, dynamically directing the laser beam towards the blank of fibrous material.

13. The method of claim 11, wherein the blank of fibrous material remains static while a laser head emitting and directing the laser beam towards the blank of fibrous material is moved upon the blank of fibrous material.

14. The method of claim 11, wherein both the blank of fibrous material and the laser beam are moved by a hybrid motion control system.

15. The method of claim 11, wherein only the blank of fibrous material is moved utilizing a movable support thereof.

16. The method of claim 1, wherein assist gas to remove debris, to improve the cutting effect of the laser beam, or both is directed towards a cutting spot.

17. The method of claim 1, wherein the blank of fibrous material is creased using by laser, mechanically, or both.

18. The method of claim 1, wherein the target design established by subjecting the blank of fibrous material to the laser beam is utilized for manufacturing a bigger, relative to the target design, three-dimensional object through 3D printing.

19. An arrangement for non-contact processing of a fibrous blank, comprising:
a laser module containing a laser source configured to exhibit a laser emission substantially at a wavelength falling within a range from about 2 to about 10.4 microns, and
a motion control system configured to direct a laser beam emitted by the laser module to the fibrous blank following a selected pattern so as to produce a target design therefrom.

20. The arrangement of claim 19, wherein the laser source comprises a gas laser.

21. The arrangement of claim 19, wherein the fibrous blank comprises a planar element of paper or cardboard.

22. The arrangement of claim 19, wherein the fibrous blank exhibits a substantially non-planar, three-dimensional shape.
